(19) United States
(12) Patent Application Publication
(10) Pub. No.: US 2018/0275731 A1
(43) Pub. Date: Sep. 27, 2018

(54) PROCESSOR RESET VECTORS

(71) Applicant: HEWLETT PACKARD ENTERPRISE DEVELOPMENT LP, Houston, TX (US)

(72) Inventors: David W. Engler, Houston, TX (US); David F. Heinrich, Houston, TX (US); Patrick Raymond, Houston, TX (US)

(21) Appl. No.: 15/464,706

(22) Filed: Mar. 21, 2017

(51) Int. Cl. G06F 1/24; G06F 3/06; G06F 12/02; G06F 9/30

(52) U.S. Cl. CPC G06F 1/24; G06F 3/0679; G06F 3/0634; G06F 9/4401; G06F 3/0619; G06F 12/0246; G06F 9/30036; G06F 3/065

(57) ABSTRACT

In an example, a system comprises a read-only memory, and a processor. The processor to: access a first reset vector, wherein the first reset vector is associated with a first memory address, wherein the first memory address is located on the read-only memory. Responsive to the processor being reset, the processor to: access a second reset vector, wherein the second reset vector is associated with a second memory address, wherein the second memory address is different than the first memory address.

### BACKGROUND

A computing device may comprise a processor. The processor may access instructions from memory

### BRIEF DESCRIPTION OF THE DRAWINGS

The following detailed description references the drawings, wherein:

FIG. 1 is a block diagram illustrating an example computing system for selecting processor reset vectors;

FIG. 2 is another example computing system illustrating selecting of processor reset vectors;

FIG. 3 is another example computing system illustrating selecting of processor reset vectors;

FIG. 4 is a flowchart of an example method for selecting processor reset vectors;

FIG. 5 is a flowchart of another example method for selecting processor reset vectors;

FIG. 6 is a block diagram of an example system for selecting processor reset vectors; and

FIG. 7 is a block diagram of another example system for selecting processor reset vectors.

### DETAILED DESCRIPTION

When a processor is reset, the processor accesses a default address. This default address is referred to as a “reset vector.” The address of the reset vector is stores a fixed (immutable) address in nearly every commercially-available processor. However, with non-volatile memory becoming more prevalent, having multiple, programmable, reset vectors may be advantageous, as a processor may be able to more-quickly boot a system from data (e.g. state data) stored on the non-volatile memory. As another example, being able to select and boot from another reset vector may be imperative if data is stored in battery-backed memory, such as a non-volatile dynamic inline memory module (NVDIMM) to quickly copy data from the battery-backed memory to non-volatile memory.

In some examples, the processor itself may select between the address of the first reset vector and a second address associated with a second reset vector. In some examples, the processor or a baseboard management controller (BMC) may select the proper reset vector, e.g. based on information about the system that is available to the BMC. In some examples, the address of the second reset vector may be located on non-volatile storage, such as re-writeable flash storage. In various examples, the address associated with the second reset vector may refer to network storage, remote storage, or any type of storage accessible to the processor. In various examples, the processor may access the address of a first reset vector upon an initial boot, and responsive to a reset (i.e. as opposed to a power cycle), the processor may access a second address of a second reset vector. A processor that has failed to boot, e.g. from the second reset vector, may revert back to the first reset vector.

Having multiple reset vectors may also be helpful in the event of a hardware failure. In such examples, a baseboard management controller may change the address of the reset vector, e.g. to point to a different address than the address of the default reset vector. The second reset vector may point to an area of memory that has instructions or routines for better handling or diagnosing certain types of errors or failures. In some examples, a user or software may specify whether the second reset vector is to be selected.

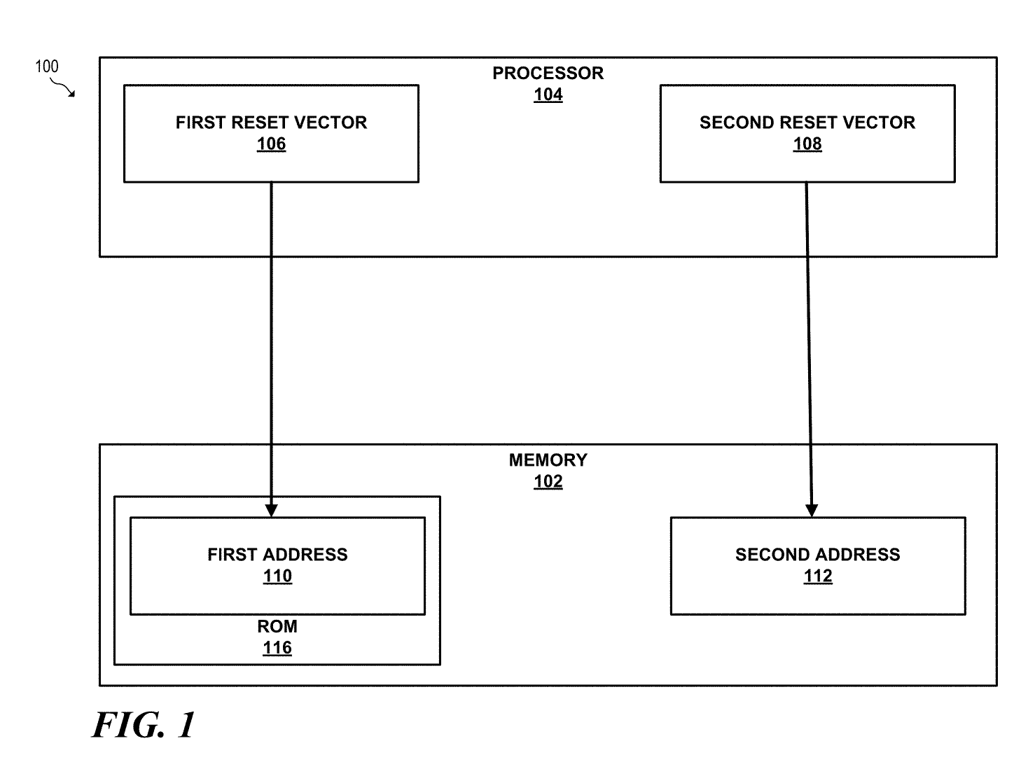

FIG. 1 is a block diagram of an example computing system 100 illustrating an example computing system for selecting processor reset vectors. System 100 comprises a memory 102, and a processor 104. Processor 104 may comprise a field programmable gate array (FPGA), application-specific integrated circuit (ASIC), microcontroller, central processing unit (CPU), digital signal processor (DSP), graphics processing unit (GPU), or any combination thereof. Although only a single processor 104 is illustrated, multiple processor may be present in system 100.

Processor 104 is coupled to memory 102. In the example of FIG. 1, memory 102 may comprise cache of processor 104, random access memory (RAM), read-only memory (ROM), electrically erasable programmable read-only memory (EEPROM); non-volatile storage, such as NAND flash, phase change memory, resistive RAM, memristor memory, network-accessible storage, remotely accessible storage, or any combination thereof, and/or the like. Although memory 102 is illustrated as being a single pool of memory, memory 102 may be spread across multiple devices, and/or may comprise multiple different types of memory.

Various address ranges of memory 102 may be mapped to different devices and/or memory types. As examples, a first address range may be mapped to an area of basic input output system (BIOS) ROM. The ROM may, for example, be located on a southbridge, or a BMC. The BMC or southbridge may be indirectly coupled to the processor by way of a northbridge. A second address range may be mapped to non-volatile memory, e.g. non-volatile memory of a non-volatile dynamic inline memory module (NVDIMM).

In the example of FIG. 1, processor may be coupled to memory 102 via at least one interface or bus, such as a double data rate (DDR) bus, peripheral component interconnect express (PCIe) bus, Serial Peripheral Interface bus (e.g. eSPI or SPI), Inter-Integrated Circuit (I²C) bus, Low Pin Count (LPC) bus, the like, or any combination thereof.

In general, upon being reset (either power cycled or soft-reset), a processor, such as processor 104 accesses data from a “reset vector.” A reset vector is the default location from which a processor, such as processor 104, accesses to find the first instruction that processor 104 is to execute after the reset. As an example, for x86 processors from the 386 or later generations, the processor reads from hexadecimal physical memory address # FFFFFFF0h (16 bytes below 4 GB).

The reset vector can be thought of as a pointer that stores a memory address. At boot or reset, the processor accesses instruction stored at the address associated with the reset vector. Typically, the address associated with the reset vector is fixed, and typically points to an address that is mapped to ROM, such as BIOS ROM or the like. The processor cannot change the address associated with the first reset vector.

It may be advantageous however, to have more than one reset vector, and for reset vectors to be programmable. A processor in accordance with this disclosure may have a programmable first reset vector, and may have multiple reset vectors. As examples, if a system component fails, it may be advantageous to boot from a different memory address comprising instructions for dealing with diagnosis, troubleshooting, or repair of the failed components. As another example, if a system is equipped with an NVDIMM comprising battery-backed volatile memory storing data that has yet to be persisted, it may be advantageous or important to quickly execute instructions that cause the stored data to be persisted to non-volatile storage. Additional examples of having multiple reset vectors will be described in greater detail herein.

In the example of FIG. 1, processor 104 has a first reset vector 106, and a second reset vector 108. Upon a cold boot, processor 104 accesses the instructions stored at first address 110. In various examples, processor 104 may map first address 110 to a ROM, e.g. ROM 116. The ROM may, e.g. be stored on a BIOS chip. The ROM may be coupled to a southbridge or a BMC in various examples.

For various reasons, processor 104 may be reset. As examples, processor 104 may be reset in the event of an operating system (OS) crash, a component failure, or the like. In the event that processor 104 is reset, processor 104 may boot system 100 by accessing second address second associated with reset vector 108.

BMC 102 may provide so-called lights-out functionality for a computing device. Lights out functionality allows a user connected to the BMC (typically using a network connection) to perform management operations on the computing device. Such management operations may comprise: power cycling the computing device, mounting media, obtaining log information, and the like.

Thus, system 100 of FIG. 1 is an example of a system (100) comprising a ROM (116), and a processor (104). The processor to: access a first reset vector (106), wherein the first reset vector is associated with a first memory address (110), wherein the first memory address is located on the ROM. Responsive to the processor being reset, the processor to: access a second reset vector (108), wherein the second reset vector is associated with a second memory address (112), wherein the second memory address is different than the first memory address.

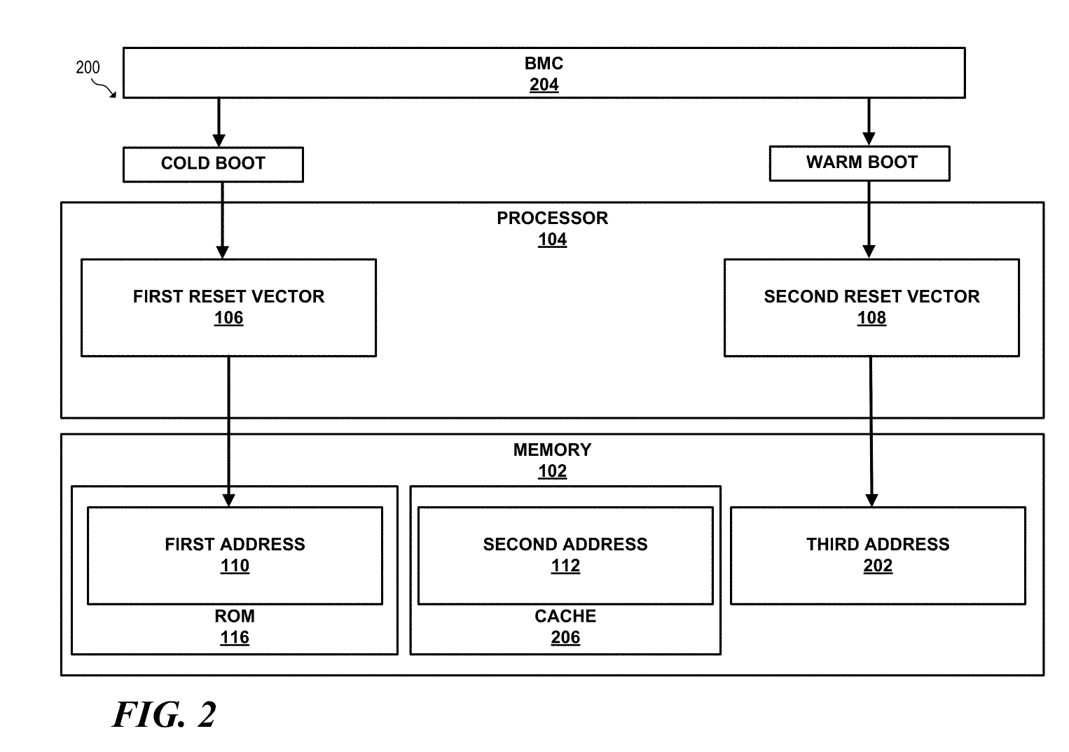

FIG. 2 is a block diagram of another example computing system 200 for selecting processor reset vectors. System 200 comprises memory 102 and processor 104, as illustrated in FIG. 1. In addition, system 200 comprises a BMC 204. BMC 204 may be coupled to processor 104 indirectly through a southbridge (not pictured). The southbridge may couple to processor 104 through a northbridge (not pictured). The southbridge may couple to BMC 204 through a bus, such as an LPC bus or an eSPI bus. In various examples, ROM 116.

In the example of FIG. 2, processor 104 may read the address stored in first reset vector 106, and access the instructions stored at first address 110. In some cases, processor 104 may be power cycled (e.g. reset,). As examples, processor 104 may be reset responsive to a software crash, such as an OS crash, or a hardware fault. Responsive to being reset, processor 104 may access an address stored in second reset vector 108. Processor 104 may access the address associated with second reset vector 108.

In the example of FIG. 2, responsive to being power cycled, processor 104 may read the address stored in second reset vector 108, access the instructions stored at the address of the second reset vector, and boot based on the accessed instructions. In the example of FIG. 2, second reset vector 108 may be mutable, that is, processor 104, BMC 204, or another processor, device, or logic, may modify the contents referenced by the address stored second reset vector 108. In some examples, second reset vector may, e.g. be stored in immutable storage of processor 104, such as ROM, a trusted platform module (TPM), or the like. In various examples, second reset vector may be stored in mutable storage, such as firmware, EEPROM, a register of processor 104, or other storage types as described herein.

In the example of FIG. 1, second reset vector stored the value of second address 112. In the example of FIG. 2, second address 112 maps to an address line in cache 206. Cache 206 may be located (e.g. a cache line) in processor 104. However, in FIG. 2, the value stored in second reset vector 108 has changed to third address 202. In some examples, processor 104 may change the address or value stored in second reset vector 108 to refer to third address 202. In other examples, another device, such as BMC 204 may change the value of second reset vector 108 to refer to third address 202.

Processor 104 may access the instructions at the address associated with first reset vector 106 responsive to a cold boot, and may access second reset vector 108 responsive to a warm boot in various examples. A warm boot may comprise a boot or a reset that occurs without interrupting system power, e.g. responsive to detecting a hardware failure, a system-initiated restart. FIG. 1 illustrates a state in which second reset vector 108 refers to second address 112. Responsive to a warm boot, processor 104 accesses the instructions stored at second address 112.

In the example of FIG. 2, processor 104 or BMC 204 may determine that an event has occurred that has caused processor 104 to have the warm boot. Examples of such an event may comprise a component failure, an operating system crash, or the like. Processor 104, BMC 204, or another device may determine the cause of the warm boot, and may change second reset vector 108 to refer to third address 202.

In various examples, a user may choose wish to cause processor 104 to boot from second reset vector 108. To indicate that processor 104 should boot from second reset vector 108, a user may set a value in software, BIOS, a register, or the like. In some examples, processor 104 may bootstrap from a first address that indicates that processor 104 should boot from the second reset vector.

Processor 104 or BMC 204 may select the address to which second reset vector 108 refers based on the determined cause of the warm boot. As an example, if processor 104 determines that a machine check exception (MCE) was asserted, processor 104 may change second reset vector 108 to refer to an address having instructions for performing error recovery or system diagnostics.

In some other examples, processor 104, BMC 204 may modify the instructions at third address 202, to which second reset vector 108 refers. Processor 104 may modify the instructions at third address 202, e.g. based on the determined reason that processor 104 was rebooted. As examples, third address 202 may refer to a region of non-volatile storage, such as NAND flash, EEPROM, or the like.

In yet other examples, the address referred to by a reset vector may be located on secure storage, for example a memory address that is encrypted or a memory address of a trusted platform module (TPM). By booting from secured storage as opposed to modifiable storage, more secure operation of computing system 200 may be ensured.

In various examples, first reset vector may act as a fail-safe reset vector in the event that there is an issue in booting from second reset vector 108. In some examples, processor 104 may revert from booting based on second reset vector 108 to booting from first reset vector 106. In some examples, processor 104 may revert to booting from first reset vector 106 if, e.g. a cache, such as cache 206, is no longer valid and should not be booted from. In various examples, processor 104 may boot from first reset vector 106 responsive to a selection by a user or software. In some examples, processor 104 may revert to booting based on first reset vector 106 based on the presence of a value, e.g. a set bit in a register. In some examples, processor 104 may determine to revert to booting from first reset vector 106 if processor 104 determines that a boot failure occurred.

As examples, processor 104, BMC 204, or the like may determine that a boot failure occurred if processor 104 encounters an invalid opcode from the instructions fetched from the address associated with second reset vector 108. In other examples, processor 104 or BMC 204 may set at timer. Upon determining that the timer has expired and processor 104 is, for example, not making progress, or processor 104 has failed to fully boot, processor 104 or BMC 204 may determine that there was a boot failure.

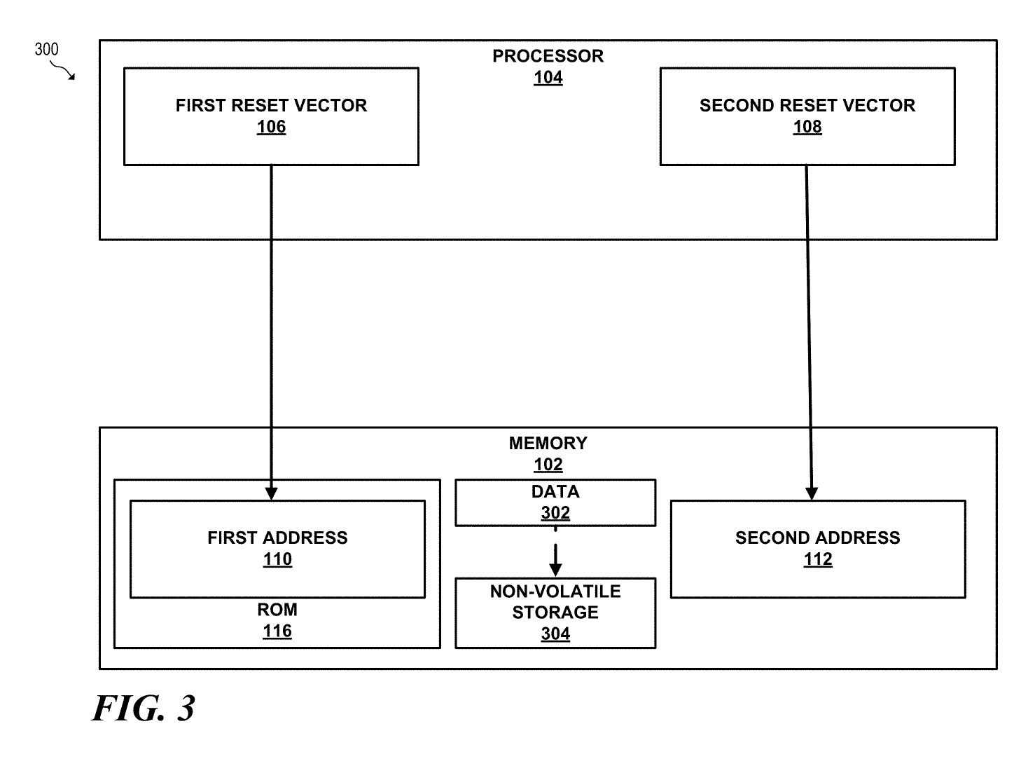

FIG. 3 is a block diagram of another example computing system 300 illustrating selecting of processor reset vectors. System 300 comprises memory 102 and processor 104, as illustrated in FIGS. 1 and 2.

In the example of FIG. 3, processor 104 may read the address stored in first reset vector 106, and access the instructions stored at first address 110, e.g. to boot system 300. Responsive to booting system 300, processor 104 or another device of computing system 300 may write data 302 to memory 102. In various examples, data 302 may be stored in an area of memory that at least temporarily survives a power cycle, e.g. an NVDIMM (which is battery-backed but is not non-volatile once the battery runs out of power).

At some time, processor 104 may be power cycled (e.g. reset). As examples, processor 104 may be reset responsive to a software crash, such as an OS crash, or a hardware fault. Responsive to being reset, processor 104 may access second address 112 associated with second reset vector 108.

In the example of FIG. 3, responsive to being power cycled, processor 104 may read the address stored in second reset vector 108, access the instructions stored at the address of the second reset vector, and boot based on the accessed instructions. In some examples, second reset vector 108 may, e.g. be stored in immutable storage of processor 104, such as ROM, a trusted platform module (TPM), or the like. In various examples, second reset vector 108 may be stored in mutable storage, such as firmware, EEPROM, or a register of processor 104.

In various examples, processor 104 may access the instructions from second address 112 responsive to a warm boot. A warm boot may comprise a boot that occurs without interrupting system power, e.g. responsive to detecting a hardware failure, a system-initiated restart. Responsive to a warm boot, processor 104 accesses the instructions stored at second address 112.

In various examples, processor 104 may determine whether data 302 is stored in an area of memory that is not permanently non-volatile, e.g. whether data 302 is stored in a battery-backed NVDIMM, and whether data 302 has been written to non-volatile storage, e.g. non-volatile storage 302. Responsive to determining that data 302 has not been written to non-volatile storage 302, processor 104, a BMC, or another device or logic may cause processor 104 to access second reset vector 108. Second reset vector may cause processor 104 to write data 302 to non-volatile storage 304. In various examples, second reset vector 108 may cause processor 104 to write data 302 to non-volatile storage 304 before booting an operating system.

In various examples, processor 104 may determine that data 302 has been written to non-volatile storage 304. Responsive to determining that data 302 has been written to non-volatile storage 304, processor 304 may still access second reset vector 108. However, reset vector 108 may not cause data 302 to be written to non-volatile storage 304 before booting an operating system.

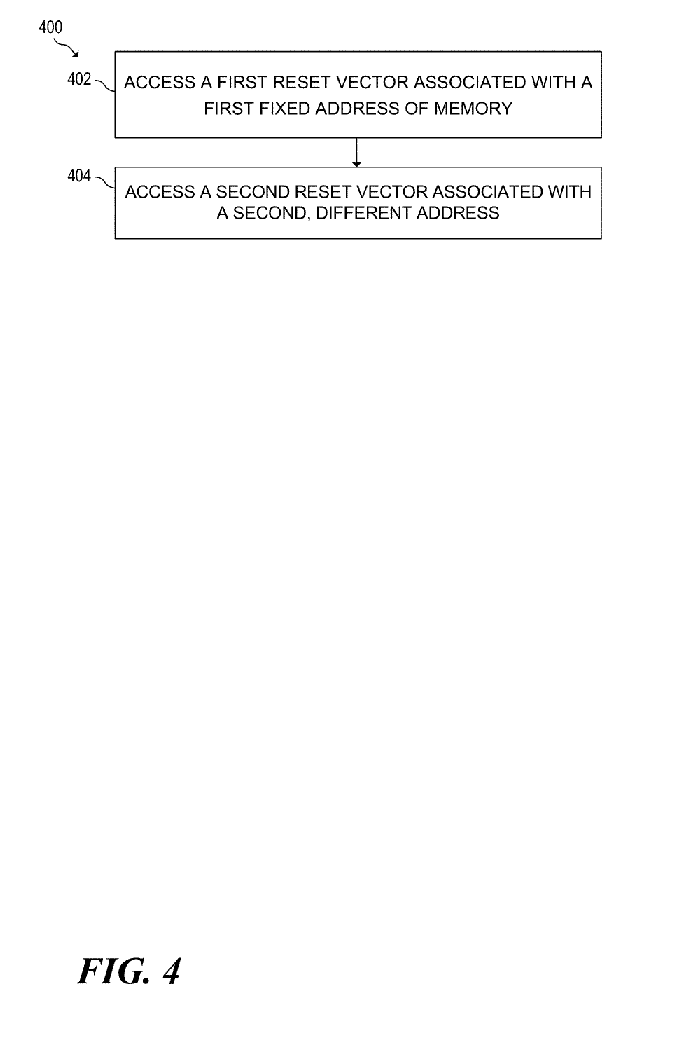

FIG. 4 is a flowchart of another example method for selecting processor reset vectors. Method 400 may be described below as being executed or performed by a system or device, for example, computing system 100 of FIG. 1, or computing system 200 of FIG. 2. Other suitable systems and/or computing devices may be used as well. Method 400 may be implemented in the form of executable instructions stored on at least one machine-readable storage medium of the system and executed by at least one processor of the system.

Alternatively or in addition, method 400 may be implemented in the form of electronic circuitry (e.g., hardware). In alternate examples of the present disclosure, one or more blocks of method 400 may be executed substantially concurrently or in a different order than shown in FIG. 4. In alternate examples of the present disclosure, method 400 may include more or less blocks than are shown in FIG. 4. In some examples, one or more of the blocks of method 400 may, at certain times, be ongoing and/or may repeat. A processor, such as processor 104, described above, may performed the method steps described herein.

Method 400 may start at block 402. Block 402 may comprise receiving, by a baseboard management controller (BMC), a request to modify a service OS, wherein the service OS is stored on non-volatile storage coupled to the BMC, and wherein the request comprises a signature. At block 404, the method may comprise determining, accessing, by a processor, a first reset vector, wherein the first vector is associated with a first fixed address of memory. At block 406, the method may comprise: responsive to the processor being reset, accessing, with the processor, a second reset vector, wherein the second reset vector is associated with a second, different address.

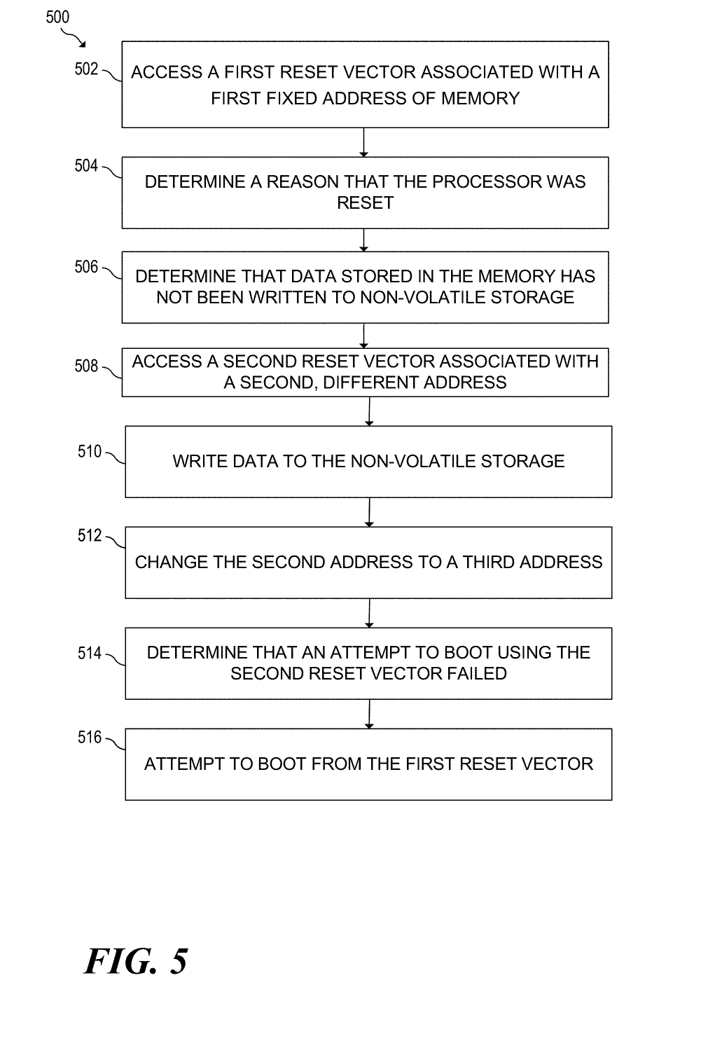

FIG. 5 is a flowchart of another example method for selecting processor reset vectors. Method 500 may be described below as being executed or performed by a system or device, for example, computing system 100 of FIG. 1, or computing system 200 of FIG. 2. Other suitable systems and/or computing devices may be used as well. Method 500 may be implemented in the form of executable instructions stored on at least one machine-readable storage medium of the system and executed by at least one processor of the system.

Alternatively or in addition, method 500 may be implemented in the form of electronic circuitry (e.g., hardware). In alternate examples of the present disclosure, one or more blocks of method 500 may be executed substantially concurrently or in a different order than shown in FIG. 5. In alternate examples of the present disclosure, method 500 may include more or less blocks than are shown in FIG. 5. In some examples, one or more of the blocks of method 500 may, at certain times, be ongoing and/or may repeat. A processor, such as processor 104, described above, may performed the method steps described herein.

Method 500 may start at block 502. Block 502 may comprise accessing, by a processor, a first reset vector, wherein the first vector is associated with a first fixed address of memory. At block 504, the method may comprise determining a reason that the processor was reset.

At block 506, the method may comprise determining that data is stored in the memory and the data has not been written to non-volatile storage. At block 508, responsive to the processor being reset the method may comprise accessing, with the processor, a second reset vector, wherein the second reset vector is associated with a second, different address. In various examples, access the second address may be based on the determined reason for resetting the processor.

At block 510, to access the second reset vector, the method comprises: writing the data to the non-volatile storage. At block 512, the method may comprise changing the second address associated with the second reset vector to a third address. In various examples, changing the second address may be performed by the processor or the BMC.

At block 512, the method may comprise: determining, by the processor, that an attempt to boot from the second reset vector failed. Responsive to determining that the attempt to boot from the second reset vector failed, at block 516, processor 104 may attempt to boot from the first reset vector.

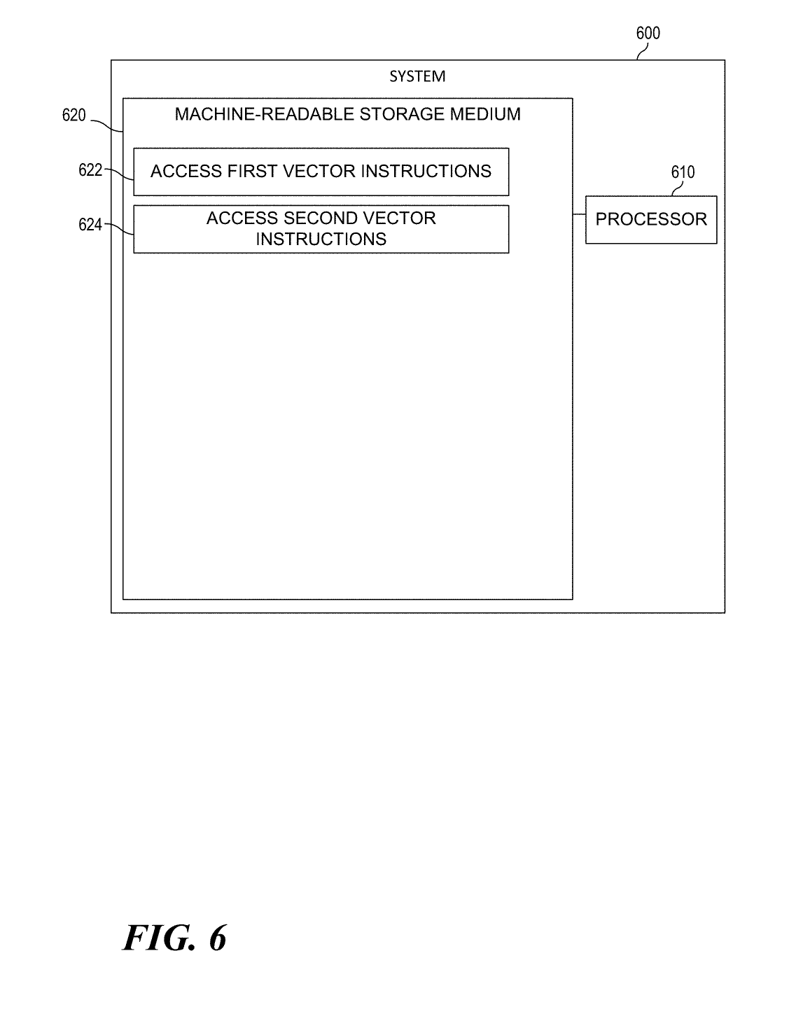

FIG. 6 is a block diagram of an example system for selecting processor reset vectors. System 600 may be similar to system 100 of FIG. 1, system 200 of FIG. 2, or system 300 of FIG. 3, for example. In the example of FIG. 6, system 600 includes a processor 610 and a machine-readable storage medium 620.

Storage medium 620 is non-transitory in various examples. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 610 may be one or more central processing units (CPUs), microprocessors, and/or other hardware devices suitable for retrieval and execution of instructions stored in machine-readable storage medium 620. In the particular examples shown in FIG. 6, processor 610 may fetch, decode, and execute instructions 622, 624, to select reset vectors. As an alternative or in addition to retrieving and executing instructions, processor 610 may include one or more electronic circuits comprising a number of electronic components for performing the functionality of one or more of the instructions in machine-readable storage medium 620. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 620 may be any electronic, magnetic, optical, or other physical storage device that stores executable instructions. Thus, machine-readable storage medium 620 may be, for example, Random Access Memory (RAM), an Electrically-Erasable Programmable Read-Only Memory (EEPROM), a storage drive, an optical disc, and the like. Machine-readable storage medium 620 may be disposed within system 600, as shown in FIG. 6. In this situation, the executable instructions may be “installed” on the system 600. Alternatively, machine-readable storage medium 620 may be a portable, external or remote storage medium, for example, that allows system 600 to download the instructions from the portable/external/remote storage medium. In this situation, the executable instructions may be part of an “installation package”. As described herein, machine-readable storage medium 620 may be encoded with executable instructions to allow modification of non-volatile storage of a BMC.

Referring to FIG. 6, access first vector instructions 622, when executed by a processor (e.g., 610), may cause processor 610 to access a first reset vector, wherein the first vector is associated with a first address of memory. In various examples, the first reset vector may be programmable. In other examples, the first reset vector may be fixed.

Access second vector instructions instructions 624, when executed, may cause processor 610 to, responsive to the processor being reset, access a second reset vector, wherein the second reset vector is associated with a second, different address.

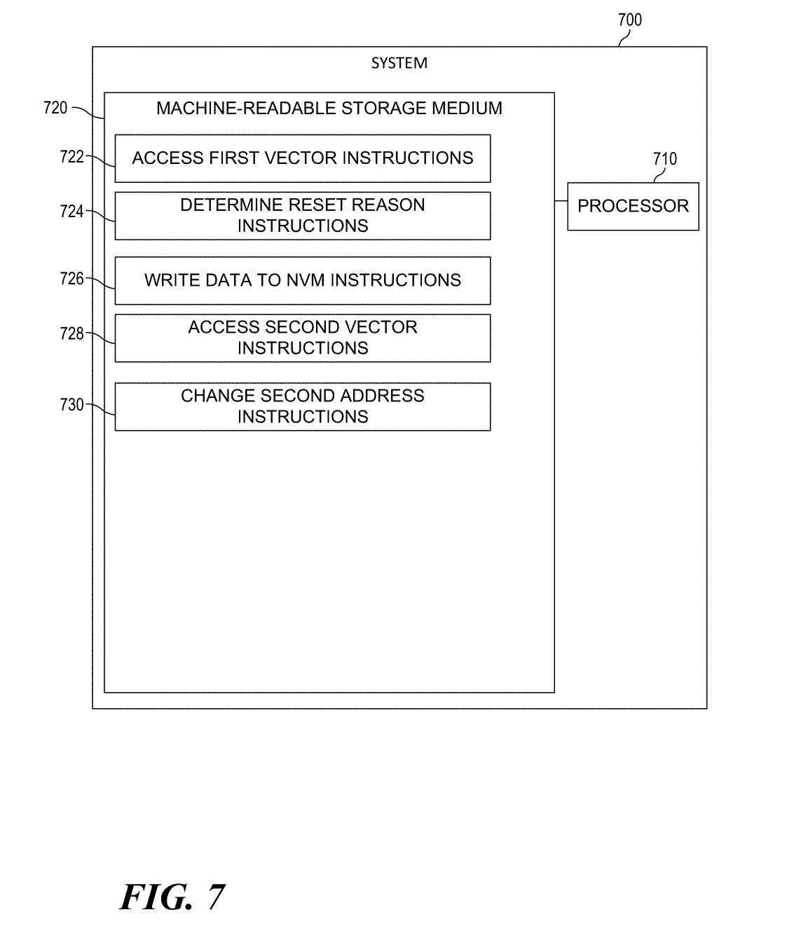

FIG. 7 is a block diagram of another example system for selecting processor reset vectors. System 700 may be similar to system 100 of FIG. 1, system 200 of FIG. 2, or system 300 of FIG. 3, for example. In the example of FIG. 7, system 700 includes a processor 710 and a machine-readable storage medium 720.

Storage medium 720 is non-transitory in various examples. Although the following descriptions refer to a single processor and a single machine-readable storage medium, the descriptions may also apply to a system with multiple processors and multiple machine-readable storage mediums. In such examples, the instructions may be distributed (e.g., stored) across multiple machine-readable storage mediums and the instructions may be distributed (e.g., executed by) across multiple processors.

Processor 710 may be one or more central processing units (CPUs), microprocessors, and/or other hardware devices suitable for retrieval and execution of instructions stored in machine-readable storage medium 720. In the particular examples shown in FIG. 7, processor 710 may fetch, decode, and execute instructions 722, 724, 726, 728, 730 to select processor reset vectors. As an alternative or in addition to retrieving and executing instructions, processor 710 may include one or more electronic circuits comprising a number of electronic components for performing the functionality of one or more of the instructions in machine-readable storage medium 720. With respect to the executable instruction representations (e.g., boxes) described and shown herein, it should be understood that part or all of the executable instructions and/or electronic circuits included within one box may, in alternate examples, be included in a different box shown in the figures or in a different box not shown.

Machine-readable storage medium 720 may be any electronic, magnetic, optical, or other physical storage device that stores executable instructions. Thus, machine-readable storage medium 720 may be, for example, Random Access Memory (RAM), an Electrically-Erasable Programmable Read-Only Memory (EEPROM), a storage drive, an optical disc, and the like. Machine-readable storage medium 720 may be disposed within system 700, as shown in FIG. 7. In this situation, the executable instructions may be “installed” on the system 700. Alternatively, machine-readable storage medium 720 may be a portable, external or remote storage medium, for example, that allows system 700 to download the instructions from the portable/external/remote storage medium. In this situation, the executable instructions may be part of an “installation package”. As described herein, machine-readable storage medium 720 may be encoded with executable instructions to allow modification of non-volatile storage of a BMC.

Referring to FIG. 7, access first vector instructions 722, when executed by a processor (e.g., 710), may cause processor 710 to access a first reset vector, wherein the first vector is associated with a first fixed address of memory.

Determine reset reason instructions 724, when executed, may cause processor 710 to determine a reason that the processor was reset. Allow write data to NVM instructions 726, when executed, may cause processor 710 to, write data from the memory to non-volatile storage.

Access second vector instructions 728, when executed, may cause processor 710 to access a second reset vector, wherein the second reset vector is associated with a second, different address. In various examples, access second vector instructions, when executed, may comprise instructions that, when executed, cause processor 710 to access the second address based on the determined reason for resetting the processor.

Change second instructions 730, when executed, may cause at least one of the processor or a baseboard management controller (BMC) to change the second address associated with the second vector.

1. A method comprising:
accessing, by a processor, a first reset vector, wherein the first reset vector is associated with a first fixed address of a memory; and
responsive to the processor being reset, accessing, with the processor, a second reset vector, wherein the second reset vector is associated with a second, different address that comprises diagnostic instructions, troubleshooting instructions, or repair instructions for a failed component, the second address being different from the first fixed address, and wherein accessing the second reset vector comprises one of: receiving a user selection of the second reset vector, or receiving an instruction from a baseboard management controller to select the second reset vector.

2. The method of claim 1, comprising:
changing the second address associated with the second reset vector to a third address.

3. The method of claim 2, wherein changing the second address is performed by the processor.

4. The method of claim 2, wherein changing the second address associated is performed by a baseboard management controller (BMC).

5. The method of claim 1, further comprising determining a reason that the processor was reset,
wherein accessing the second address is based on the reason for resetting the processor.

6. The method of claim 1, comprising:
responsive to determining that the processor was reset:
determining that data is stored in the memory and the data has not been written to non-volatile storage,
wherein accessing the second reset vector comprises:
writing the data to the non-volatile storage.

7. The method of claim 1, wherein the second reset vector is stored on re-writeable non-volatile storage comprising at least one of an NVDIMM (non-volatile dynamic inline memory module), or NAND storage.

8. The method of claim 1, comprising:
determining, by the processor, that an attempt to boot from the second reset vector has failed; and
responsive to determining that the attempt to boot from the second reset vector ha failed:
attempting, by the processor, to boot from the first reset vector.

9. The method of claim 1, wherein the second address is stored in a cache of the processor.

10. A system comprising:
a read-only memory (ROM); and
a processor, the processor configured to:
access, in a first memory address, a first reset vector, wherein the first reset vector is associated with a first memory address, wherein the first memory address is located on the ROM; and
responsive to the processor being reset, the processor is configured to:
access, in a second memory address, a second reset vector, wherein the second reset vector is associated with a second memory address, wherein the second memory address is different than the first memory address and comprises diagnostics instructions, troubleshooting instructions, or repair instructions for a failed component and wherein to access a second reset vector the processor is configured to one of: receive a user selection of the second reset vector, or receive an instruction from a baseboard management controller to select the second reset vector.

11. The system of claim 10, wherein the processor to:
change the second memory address associated with the second reset vector to a third memory address, wherein the third memory address is different than the first memory address and the second memory address.

12. The system of claim 11, changing the second memory address of the second reset vector is performed by the processor.

13. The system of claim 10, changing the second memory address of the second reset vector is performed by the baseboard management controller (BMC).

14. The system of claim 10, wherein the processor to:
determine a reason that the processor was reset; and
access the second memory address of the second reset vector based on the determined reason for resetting the processor.

15. The system of claim 10, comprising:
wherein to accessing the second reset vector, the processor to:
accessing the second memory address; and
write a data stored in the memory ROM to non-volatile storage.

16. The system of claim 10, wherein the second memory address is stored in a cache of the processor.

17. A non-transitory computer-readable storage medium comprising instructions stored thereon that, when executed by a processor, cause the processor to:
access, in a first address of a memory, a first reset vector, wherein the first reset vector is associated with a first address of a memory; and
responsive to the processor being reset, access, in a second address of the memory, a second reset vector, wherein the second reset vector is associated with a second, different address that comprises diagnostics instructions, troubleshooting instructions, or repair instructions for a failed component, and wherein to access the second reset vector the instructions further cause the processor to one of: receive a user selection of the second reset vector, or receive an instruction from a baseboard management controller to select the second reset vector.

18. The non-transitory computer-readable storage medium of claim 17, comprising instructions that, when executed, cause at least one of the processor or the baseboard management controller (BMC) to change a second memory address associated with the second reset vector.

19. The non-transitory computer-readable storage medium of claim 17, wherein the instructions that cause the processor to access the second reset vector comprise instructions cause the processor to write data from the memory to non-volatile storage.

20. The non-transitory computer-readable storage medium of claim 17, comprising instructions stored thereon that, when executed, cause the processor to:
determine a reason that the processor was reset,
wherein the instructions that cause the processor to access the second address associated with the second reset vector comprise instructions, that when executed, cause the processor to access the second address based on the determined reason for resetting the processor.
